(19) United States
(12) Patent Application Publication
(10) Pub. No.: US 2024/0184965 A1
(43) Pub. Date: Jun. 6, 2024

(54) CALCULATION RESOURCE CONTROL DEVICE AND CONTROL METHOD

(71) Applicant: Nippon Telegraph and Telephone Corporation, Tokyo (JP)

(72) Inventors: Yuki Arikawa, Tokyo (JP); Kenji Tanaka, Tokyo (JP); Tsuyoshi Ito, Tokyo (JP); Tsutomu Takeya, Tokyo (JP); Takeshi Sakamoto, Tokyo (JP)

(21) Appl. No.: 18/554,287

(22) PCT Filed: Apr. 28, 2021
(86) PCT No.: PCT/JP2021/016968

§ 371 Date: Oct. 6, 2023

(51) Int. Cl. G06F 30/337; G06F 119/02

(52) U.S. Cl. CPC G06F 30/337; G06F 2119/02

(57) ABSTRACT

A calculation resource control device includes an input unit to which a processing content specified by a user is input, an equivalent circuit preparation unit that collects candidates for an equivalent circuit that is a processing circuit having a function of executing a part of the processing content to output an equivalent circuit candidate group, and a function chain creation unit that determining a processing execution circuit from the equivalent circuit candidate group on the basis of a predetermined reference, determines a connection order of the processing execution circuit, and outputs a function chain for executing the processing content.

### CROSS-REFERENCE TO RELATED APPLICATIONS

This application is a national phase entry of PCT Application No. PCT/JP2021/016968, filed on Apr. 28, 2021, which application is hereby incorporated herein by reference.

### TECHNICAL FIELD

The present invention relates to a calculation resource control device and a calculation resource control method used in a computer system and the like.

### BACKGROUND

Technical innovations in many fields, such as machine learning, artificial intelligence (AI) and IoT (Internet of things), have been developed, making services more sophisticated and providing added value by utilizing a variety of information and data. In order to execute a large amount of calculations in the processing of the information and data, an information processing base is essential.

For example, it is difficult to deal with rapidly increasing data by updating an existing information processing base, and further progress in the future will require the establishment of “post-Moore technology” that goes beyond Moore's Law (NPL 1).

Flow-centric computing is disclosed in, for example, NPL 2 as post-Moore technology. Flow-centric computing differs from the traditional concept of computing in which processing is performed where the data is located, and a new concept is proposed in which data is moved to a place where a calculation function resides for processing.

In order to realize this flow-centric computing, a high-bandwidth communication network for data movement is required, as well as technology to efficiently control calculation resources to achieve the desired computing performance.

### CITATION LIST

### Non Patent Literature

NPL 1 “NTT Technology Report for Smart World 2020,” Nippon Telegraph and Telephone Corporation, 2020.

NPL 2 R. Takano and T. Kudoh, “Flow-centric computing leveraged by photonic circuit switching for the post-Moore era,” Tenth IEEE/ACM International Symposium on Networks-on-Chip (NOCS), Nara, 2016, pp. 1-3.

### SUMMARY

### Technical Problem

In general flow-centric computing (e.g., NPL 2), a method for controlling, operating, and managing whether to secure calculation resources is disclosed.

However, no method has been disclosed to optimize the processing circuits that perform such processing and efficiently control, operate, and manage calculation resources.

### Solution to Problem

In order to solve the problems described above, a calculation resource control device according to embodiments of the present invention includes an input unit to which a processing content specified by a user is input, an equivalent circuit preparation unit that collects candidates for an equivalent circuit that is a processing circuit having a function of executing a part of the processing content, to output an equivalent circuit candidate group, and a function chain creation unit that determines a processing execution circuit from the equivalent circuit candidate group according to a predetermined reference, determines a connection order of the processing execution circuit, and outputs a function chain for executing the processing content.

A calculation resource control method according to embodiments of the present invention includes the steps of: inputting a processing content specified by the user; collecting candidates of a processing circuit having a function of executing a part of the processing content, to output an equivalent circuit candidate group; determining a processing execution circuit from the equivalent circuit candidate group; and outputting a function chain for executing the processing content.

### Advantageous Effects of Embodiments of the Invention

According to embodiments of the present invention, a calculation resource control device and a calculation resource control method capable of efficiently controlling, operating, and managing calculation resources can be provided.

### BRIEF DESCRIPTION OF THE DRAWINGS

FIG. 1A is a block diagram showing a configuration of a calculation resource control device according to a first embodiment of the present invention.

FIG. 1B is a block diagram showing a configuration of a conventional calculation resource control device.

FIG. 2 is a flowchart for explaining a calibration resource control method according to the first embodiment of the present invention.

FIG. 3 is a diagram for explaining an example of the calculation resource control method according to the first embodiment of the present invention.

FIG. 4 is a diagram for explaining an example of the calculation resource control method according to the first embodiment of the present invention.

FIG. 5 is a diagram for explaining an example of the calculation resource control method according to the first embodiment of the present invention.

FIG. 6 is a diagram for explaining an example of the calculation resource control method according to the first embodiment of the present invention.

FIG. 7 is a block diagram showing a configuration of a calculation resource control device according to a second embodiment of the present invention.

FIG. 8 is a flowchart for explaining a calculation resource control method according to the second embodiment of the present invention.

FIG. 9 is a block diagram showing a configuration of a calculation resource control device according to a third embodiment of the present invention.

FIG. 10 is a flowchart for explaining a calculation resource control method according to the third embodiment of the present invention.

### DETAILED DESCRIPTION OF ILLUSTRATIVE EMBODIMENTS

### First Embodiment

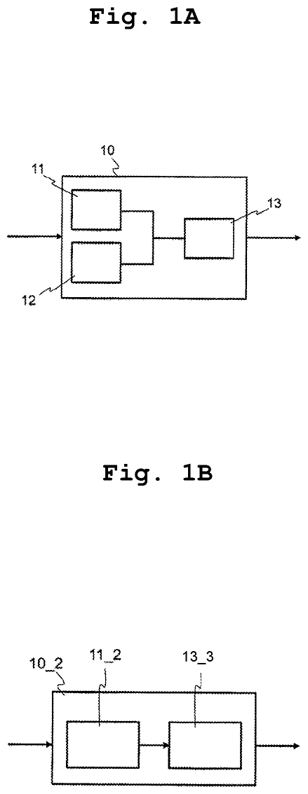

A calculation resource control device and a calculation resource control method according to a first embodiment of the present invention will be described with reference to FIGS. 1A to 6.

### Configuration of Calculation Resource Control Device

As shown in FIG. 1A, a calculation resource control device 10 according to the present embodiment includes an input unit 11, an equivalent circuit preparation unit 12, and a function chain creation unit 13. The calculation resource control device 10 is connected to a computer system such as an arithmetic unit or functions as a part of the computer system.

A processing content specified by a user is input to the input unit 11.

The equivalent circuit preparation unit 12 collects candidates of a processing circuit equipped with a function for executing a part of the processing content specified by the user (hereinafter referred to as “equivalent circuits”), and outputs the candidates as an equivalent circuit candidate group.

As the candidates for a processing circuit, circuits with different parameters that define circuit characteristics, such as processing performance (latency and throughput), consumption of calculation resources such as a circuit area and FPGA resources, and power consumption, are collected.

When collecting circuits having different characteristics, the equivalent circuit preparation unit 12 can hold candidates of available circuits in advance as a database.

Further, by maintaining the basic design of a circuit and changing parameters for determining the characteristics of the circuit in the basic design, a circuit with equivalent input/output information and different characteristics may be created each time.

For example, when there is a parameter for designating the number of parallel executions on internal processing of the circuit in a source code of the basic design, a circuit in which the parameter is changed by a predetermined number of times within a predetermined range is created. In the case of using an FPGA, a source code is provided in advance, and a parameter of the source code is changed to execute processes of synthesis and implementation of the circuit, and bit stream generation, whereby circuits having different characteristics are prepared.

The function chain creation unit 13 determines circuits necessary to execute the processing content specified by the user (hereinafter referred to as “processing execution circuit”), from the equivalent circuit candidate group output by the equivalent circuit preparation unit 12, according to a predetermined criterion, determines a connection order for the circuits, and outputs a function chain for executing the processing content specified by the user.

Examples of the predetermined criterion for determining the circuits includes the processing content specified by the user. Specifically, the examples include “processing time (latency) priority,” “calculation resource consumption priority,” “input condition priority,” and “throughput priority.” The function chain may be generated by applying a plurality of processing contents as AND conditions according to the priority.

For comparison, FIG. 1B shows a configuration of a conventional calculation resource control device 10_2.

In the conventional calculation resource control device 10_2, a function chain creation unit 13_3 creates a function chain without considering the restriction (condition) of processing on the basis of the processing content input to an input unit 11_2.

On the other hand, since the calculation resource control device 10 according to the present embodiment is provided with the equivalent circuit preparation unit 12, the function chain creation unit 13 can determine the processing execution circuit from the equivalent circuit candidate group output by the equivalent circuit preparation unit 12, according to a predetermined criterion.

Thus, with respect to a predetermined criterion for determining the circuit, the user can specify processing contents such as “processing time (latency) priority,” “calculation resource consumption priority,” “input condition priority,” and “throughput priority.”

Further, when creating the function chain on the basis of “processing time (latency) priority,” and particularly when there is no restriction in the calculation resource consumption, there is an effect that the function chain can be created by combining circuits having the shortest processing time. On the other hand, when there is a restriction in the calculation resource consumption, there is an effect that the function chain can be created by combining circuits having the shortest processing time under the restriction condition.

### Calculation Resource Control Method

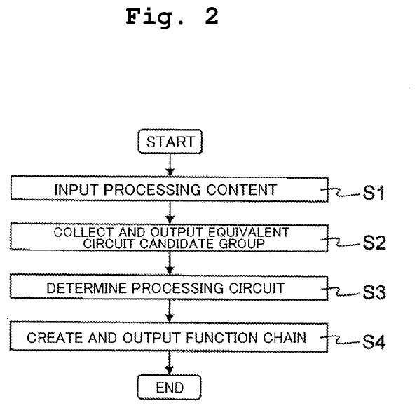

The calculation resource control method according to the present embodiment will be described with reference to FIG. 2.

First, a processing content specified by a user is input (step S1).

Next, candidates of a processing circuit having a function for executing a part of the input processing content are collected, and an equivalent circuit candidate group is output (step S2).

Next, a processing execution circuit is determined from the equivalent circuit candidate group according to a prescribed reference (step S3).

Finally, a function chain for executing the processing content specified by the user is created and output by determining a connection order of the processing execution circuit (step S4).

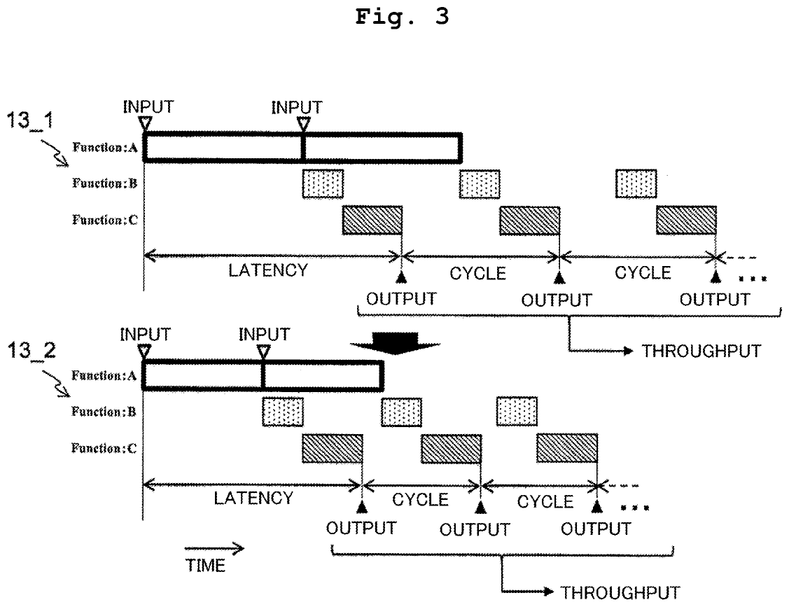

Next, the creation of the function chain in the control method according to the present embodiment will be described in detail. FIGS. 3 to 6 show examples of the configuration of the function chain based on the processing content specified by the user.

For example, as shown in FIG. 3, when “processing time (latency) priority” is selected, the function chain is created by combining circuits in which the processing time (latency) of each circuit constituting the function chain is minimized. In the drawings, reference numeral 13_1 indicates an example of the configuration of the function chain prior to a change, and reference numeral 13_2 indicates an example of the configuration of the function chain after a change.

In this case, if there are enough circuit resources available, a pipeline (Function: A) with the longest processing time is changed to a circuit with shorter processing time. This reduces latency. In addition, since the output cycle can be shortened, the amount of output per unit time (throughput) can be improved.

In addition, the next function chain is created by changing any one of the circuits constituting the function chain having the shortest processing time, and then combining the circuits having the second (next) shortest processing time.

Similarly, the circuits are combined with each other in the ascending order of the processing time to create a function chain. Particularly, when there is no restriction in the calculation resource consumption, a function chain obtained by combining circuits with the shortest processing time is output. On the other hand, when there is a restriction in the calculation resource consumption, a function chain obtained by combining circuits having the shortest processing time under a restriction condition is selected and output.

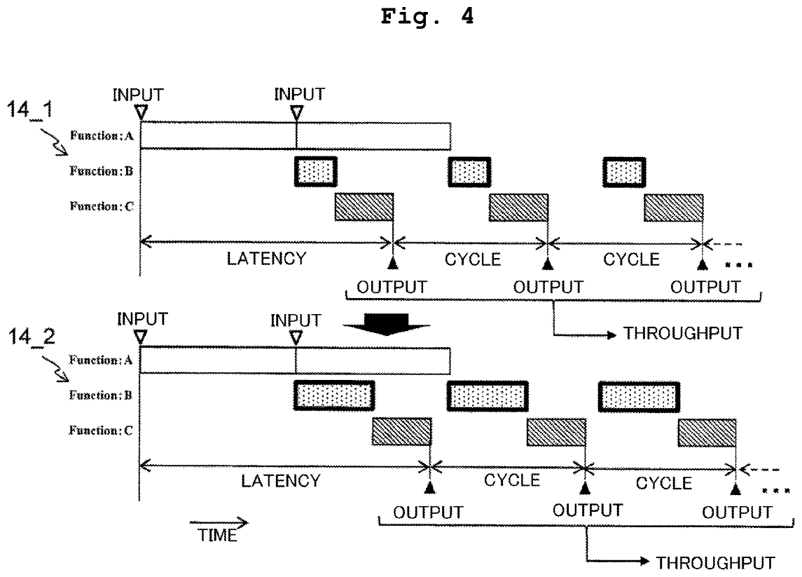

As shown in FIG. 4, when “calculation resource consumption priority” is selected, a function chain is created by combining circuits in which the calculation resource consumption of each circuit constituting the function chain is minimized. In the drawings, reference numeral 14_1 indicates an example of the configuration of the function chain prior to a change, and reference numeral 14_2 indicates an example of the configuration of the function chain after a change.

In this case, an increase in the processing time in a pipeline (Function: B) where there is a margin of processing time to the extent that a decline in throughput performance can be controlled is allowed, and the circuit (Function:B) is changed to a circuit having lower calculation resource consumption. Thus, the throughput can be maintained and the calculation resource consumption can be reduced.

In addition, the next function chain is created by changing any one of the circuits constituting the function chain having the shortest calculation resource consumption, and then combining the circuits having the second (next) shortest calculation resource consumption.

Similarly, circuits are combined with each other in the ascending order of the calculation resource consumption to create a function chain. Particularly, when there is no restriction in the processing time, a function chain obtained by combining circuits having the shortest calculation resource consumption is output. On the other hand, when there is a restriction in the processing time, a function chain obtained by combining circuits having the shortest calculation resource consumption under the restriction condition is selected and output.

When “input condition priority” is selected, the circuits are combined with each other so as to meet the constraints of the external input speed to the circuits in the first stage of the function chain. When an input packet from the outside is input at a 100 microsecond cycle, the circuits are combined with each other so that the processing time is such that there is no delay in processing in a circuit of the subsequent stage, that is, such that a pipeline exceeding 100 microseconds is not included, to create a function chain.

When “throughput priority” is selected, the function chain is created by combining circuits with each other so as to maximize the output throughput of the function chain.

In addition, the next function chain is created by changing any one of the circuits constituting the function chain in which the output throughput becomes maximum, and then combining the circuits having the second (next) highest output throughput.

In the same manner, the circuits are combined with each other in the descending order of the output throughput, to create a function chain. Particularly, when there is no restriction on the calculation resource consumption, the function chain obtained by combining circuits having the maximum output throughput of the function chain is output. On the other hand, when there is a restriction in the calculation resource consumption, the function chain obtained by combining circuits having the maximum output throughput of the function chain under the restriction condition is selected and output.

When the throughput does not change and the increase of the processing time is within an allowable range, the function chain is created by combining circuits having the minimum calculation resource consumption.

When pipeline processing is performed in a function chain, even if only a part of the circuits constituting the function chain has a short processing time, the processing time increases within an allowable range if the processing time of other circuits is long, but the change in the output throughput can be considered to be within the margin of error. Therefore, a function chain is created by combining circuits having minimum calculation resource consumption. In this case, it is possible to minimize the time when each circuit constituting the function chain is in an idle state.

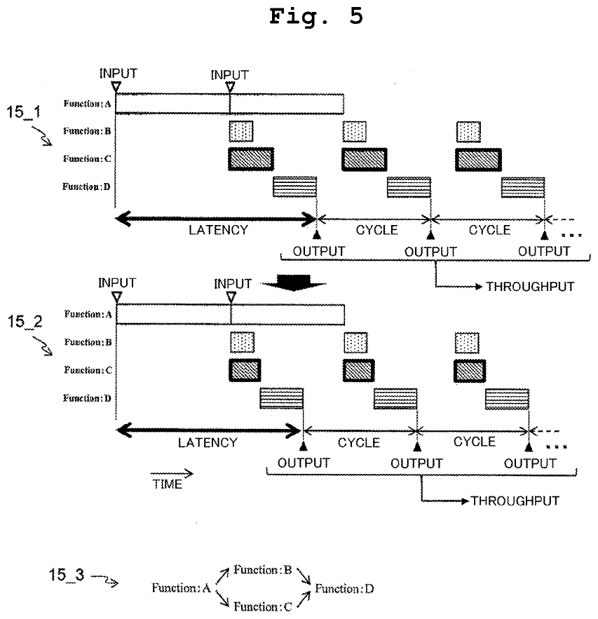

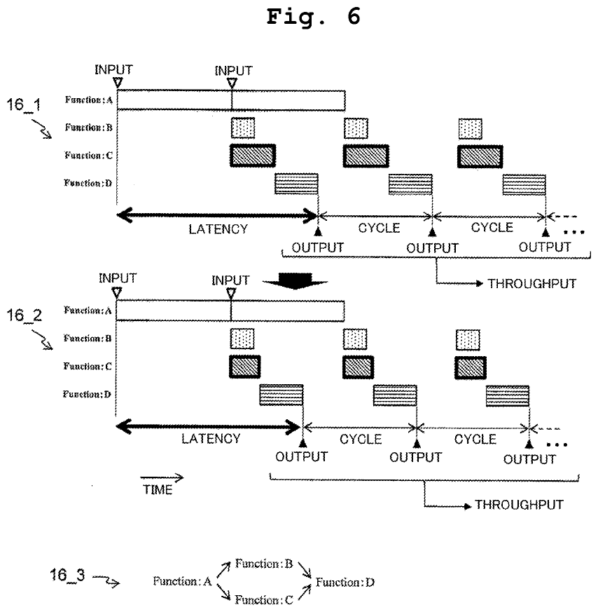

The creation of a function chain when branch processing requiring synchronization between the processing circuits is included will be described with reference to FIGS. 5 and 6. In the drawings, reference numerals 15_1 and 16_1 show examples of the configuration of a function chain prior to a change of a processing circuit, and reference numerals 15_2 and 16_2 show examples of the configuration of the function chain after a change of the processing circuit. Further, reference numerals 15_3 and 16_3 show modes of branch processing between processing circuits.

In this case, the entire processing time is achieved by creating a function chain in such a manner that the branch processing is processed in parallel.

For example, when there are enough circuit resources available, the circuit is changed to a circuit having the shortest processing time of a pipeline (Function: C) having the longest processing time, as shown in FIG. 5. Thus, latency can be reduced and throughput can be improved.

For example, as shown in FIG. 6, an increase in the processing time in the pipeline (Function:B) where there is a margin of processing time to the extent that a decline in throughput performance can be controlled is allowed, and the circuit (Function:B) is changed to a circuit having lower calculation resource consumption. Thus, the throughput can be maintained and the calculation resource consumption can be reduced.

Note that candidates of the processing circuit constituting the function chain may be taken as information input from the outside. In this case, the equivalent circuit preparation unit 12 prepares candidates for the equivalent circuit so as to include candidates for the processing circuit input from the outside, and inputs them to the function chain creation unit 13 on the subsequent stage.

### Effects

According to the calculation resource control device and the calculation resource control method according to the present embodiment, when creating a function chain, it is possible to shorten the processing time, reduce the consumption of calculation resources, and provide highly flexible calculation resource control.

In the process of creating a function chain by combining a plurality of processing circuit candidates, the function chain can be created based on the processing content of the function chain specified by the user.

In addition, in the function chain that includes branch processing, the consumption of calculation resources can be reduced without changing the processing performance.

### Second Embodiment

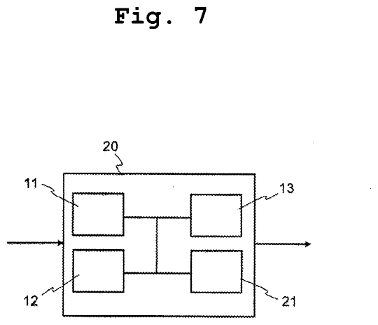

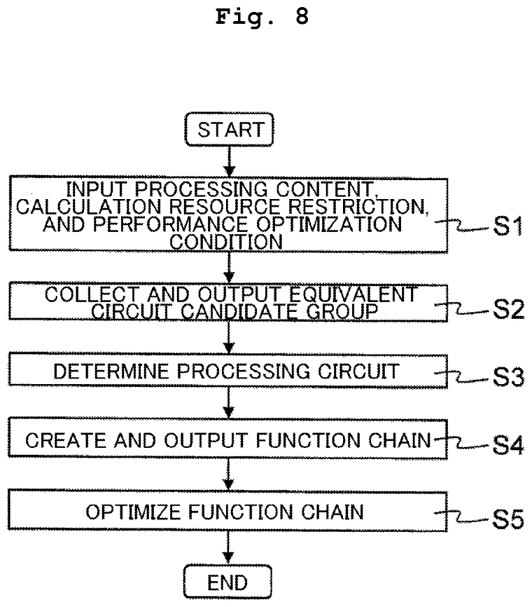

A calculation resource control device and a calculation resource control method according to a second embodiment of the present invention will be described below with reference to FIGS. 7 and 8.

### Configuration of Calculation Resource Control Device

As shown in FIG. 7, a calculation resource control device 20 according to the present embodiment includes the input unit 11, the equivalent circuit preparation unit 12, the function chain creation unit 13, and a chain optimization unit 21. In the calculation resource control device 20, the equivalent circuit preparation unit 12 and the function chain creation unit 13 are the same as those of the first embodiment, and the calculation resource control device 20 is different from that of the first embodiment in that the calculation resource control device 20 includes the chain optimization unit 21.

A calculation resource restriction and a performance optimization condition are input to the input unit 11 together with a processing content specified by the user. The calculation resource restriction and the performance optimization condition may be input by the user or may be automatically input from a computer system.

Here, the calculation resource restriction is, for example, the state of the entire computer system (e.g., usage status, projected usage, and the like).

The performance optimization condition is, for example, a specified priority. Here, the “priority” indicates the order of priority of the processing for which the chain is to be created in the computer system.

Also, the performance optimization condition is, for example, a response to a request for the provision of calculation resources to a processing unit other than the processing unit described above.

The chain optimization unit 21 optimizes the function chain on the basis of the calculation resource restriction and the performance optimization condition in addition to user-specified treatment details.

### Calculation Resource Control Method

The calculation resource control method according to the present embodiment will be described with reference to FIG. 8.

In the calculation resource control method according to the present embodiment, the same steps (steps S1 to S4) as those of the calculation resource control method according to the first embodiment are executed, and thereafter the function chain is optimized (step S5). Here, the chain optimization unit 21 optimizes the function chain as described above.

The optimization of a function chain in the control method according to the present embodiment will be described in detail below.

For example, in a case where the usage status of a calculation resource at an arbitrary time point is used for optimization of a function chain, when the usage status of the calculation resource is higher than a predetermined reference, the chain optimization unit 21 reduces the processing performance to a predetermined performance so that the consumption of the calculation resource in the foregoing processing can be reduced.

On the other hand, when the usage status of the calculation resource at an arbitrary time point is lower than the predetermined reference, the chain optimization unit 21 optimizes the processing performance so as to satisfy the desired performance, without providing any restriction on the calculation resource consumed by the processing.

In a case where the projected usage of the calculation resource based on a future prediction is used for the optimization of a function chain, when the projected usage of the calculation resource is higher than a predetermined reference, the chain optimization unit 21 suppresses the processing performance to a predetermined performance so that the consumption of the calculation resource in the foregoing processing can be reduced.

On the other hand, when the projected usage of the calculation resource is lower than the predetermined reference, the chain optimization unit 21 optimizes the processing performance so as to satisfy the desired performance, without providing any restriction on the calculation resource consumed by the processing.

In this manner, the function chain can be optimized by the chain optimization unit 21 based on a calculation resource restriction.

In a case where the optimization of the function chain is performed on the basis of the designation of the priority, when a calculation resource for processing so as to satisfy a desired performance is sufficiently provided, the chain optimization unit 21 optimizes the processing performance so as to satisfy the desired performance, without providing any restriction on the calculation resource consumed by the processing.

On the other hand, when a calculation resource for processing so as to satisfy the desired performance is not sufficiently provided, processing with low priority is requested so that the calculation resource is provided from processing with low priority.

In so doing, when the calculation resource can be provided and the calculation resource for processing so as to satisfy the desired performance is sufficiently provided, the processing performance is optimized so as to satisfy the desired performance without providing any restriction on the calculation resource consumed by the processing.

When the calculation resource can be provided but the calculation resource for processing so as to satisfy the desired performance is not sufficiently provided, the provided calculation resource is added, and the processing performance is optimized so as to approach the desired performance, with the calculation resource usable for the processing as an upper limit.

Also, when the calculation resource cannot be provided and the calculation resource for processing so as to satisfy the desired performance is not sufficiently provided, the processing performance is optimized so as to approach the desired performance, with the calculation resource available for the processing as an upper limit.

In this manner, the function chain can be optimized by the chain optimization unit 21 based on the performance optimization condition.

### Effects

According to the calculation resource control device and the calculation resource control method according to the present embodiment, since the chain can be optimized based on the calculation resource restriction or the performance optimization condition, it is possible to shorten the processing time, reduce the consumption of calculation resources, and provide highly flexible calculation resource control.

Although the present embodiment has illustrated an example in which the chain is optimized based on either the calculation resource restriction or the performance optimization condition, the chain may be optimized based on both the calculation resource restriction and the performance optimization condition.

### Third Embodiment

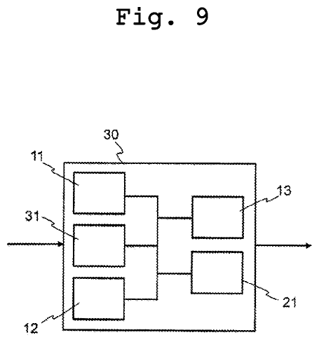

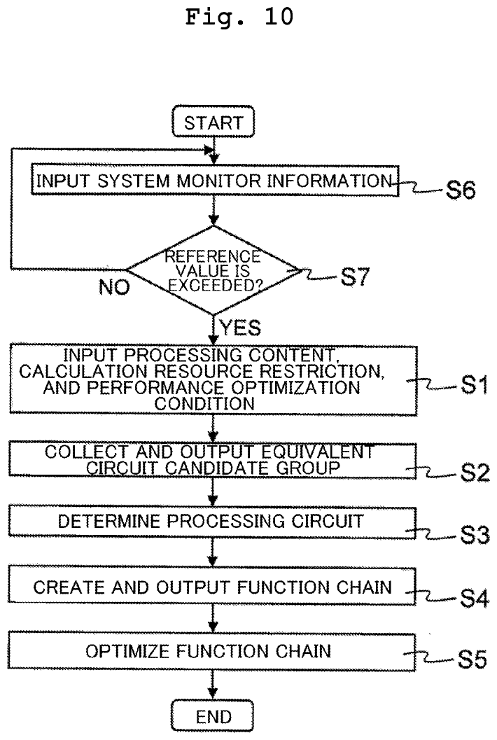

A calculation resource control device and a calculation resource control method according to a third embodiment of the present invention will be described with reference to FIGS. 9 to 10.

### Configuration of Calculation Resource Control Device

A calculation resource control device 30 according to the present embodiment includes the input unit 11, the equivalent circuit preparation unit 12, the function chain creation unit 13, the chain optimization unit 21, and a dynamic chain control unit 31. In the calculation resource control device 30, the equivalent circuit preparation unit 12, the function chain creation unit 13, and the chain optimization unit 21 are the same as those of the second embodiment, and the calculation resource control device 30 is different from that of the second embodiment in that the calculation resource control device 30 includes the dynamic chain control unit 31.

The usage status of calculation resources for the entire system and the progress of processing in response to user processing requests are input to the input unit 11. Hereinafter, the usage status of the calculation resources of the entire system, the progress of processing in response to the processing request from the user and the like are referred to as “system monitor information.” In addition, as in the second embodiment, a calculation resource restriction and a performance optimization condition are input together with a processing content specified by the user.

The system monitor information may be input by the user or automatically input from the computer system. Further, the calculation resource restriction and the performance optimization condition may be input by the user or automatically input from the computer system.

The dynamic chain control unit 31 determines the regeneration of a function chain with a predetermined reference value on the basis of the system monitor information. For example, the regeneration of the function chain is started when the value exceeds a predetermined reference value. Here, the predetermined reference value is a value indicating a usage state of a calculation resource of the entire system and a value indicating a progress of processing in response to a processing request from the user.

### Calculation Resource Control Method

The calculation resource control method according to the present embodiment will be described with reference to FIG. 10.

First, system monitor information is input (step S6).

Next, the system monitor information is determined by a predetermined reference value (step S7). When the system monitor information exceeds the prescribed reference value, a function chain is created hereinafter in the same manner as the first or second embodiment (steps S1 to S5).

When the system monitor information is less than or equal to the prescribed reference value, the system monitor information is input again (step S6). Here, the system monitor information may be continuously input or may be input at an arbitrary point of time.

The start of the function chain regeneration in the control method according to the present embodiment will be described in detail below.

For example, when the input system monitor information exceeds the predetermined reference value, regeneration of the function chain is started to change the processing circuit so as to reduce the calculation resources for low-priority processing.

Further, the system may be requested to add a calculation resource.

Also, when implementing processing circuits with the FPGA as a calculation resource, calculation resources can be added by increasing the number of available FPGAs.

Although the present embodiment has illustrated an example of starting the processing for creating a function chain when the usage state exceeds the standard, the processing for creating a function chain may be started when the usage state falls below the standard.

For example, when the usage state is lower than the predetermined reference value, function chain regeneration for changing the processing circuit is started so as to provide a calculation resource to the processing in which the usage state is tight in other function chain creation processing.

Further, the number of available FPGAs may be reduced.

### Effect

According to the calculation resource control device and the calculation resource control method according to embodiments of the present embodiment, calculation resources can be distributed based on the usage state, securing calculation resources under high load conditions and improving processing performance under low load conditions.

The present embodiment has illustrated an example applied to the second embodiment. However, the example may be applied to the first embodiment. In this case, the calculation resource control device includes the input unit 11, the equivalent circuit preparation unit 12, the function chain creation unit 13, and the dynamic chain control unit 31, and achieves the same effects.

In the embodiments of the present invention, when the processing content specified by the user (master processing) is executed by combining a plurality of processing circuits (slave processing), for example, when the entire function chain consists of an upper function chain (master processing) and a lower function chain (slave processing), the user may specify the processing content for the slave processing.

Alternatively, the user may specify the processing content only for the master processing. In this case, the computer system can automatically select the processing content specified for the master processing and specify the processing content for the slave processing.

### Extension of Embodiments

Embodiments of the present invention have been described thus far with reference to exemplary embodiments, but the embodiments of the present invention are not limited to the above embodiments. The configuration and details of the embodiments of the present invention can be altered in various manners which can be understood by those skilled in the art within the scope of the present invention. Furthermore, each embodiment can be implemented in any combination to the extent that it is not contradictory.

### INDUSTRIAL APPLICABILITY

Embodiments of the present invention can be applied to a computer system or the like as the calculation resource control device and the calculation resource control method.

1.-6. (canceled)

7. A calculation resource control device, the device comprising:
an input device configured to receive an input of a processing content specified by a user;
an equivalent circuit preparation circuit configured to collect candidates for an equivalent circuit to output an equivalent circuit candidate group, the equivalent circuit comprising a processing circuit having a function of executing a part of the processing content; and
a function chain creation circuit configured to determine a processing execution circuit from the equivalent circuit candidate group according to a predetermined reference, determine a connection order of the processing execution circuit, and output a function chain for executing the processing content.

8. The device according to claim 7, wherein the processing execution circuit is determined by the processing content specified by the user.

9. The device according to claim 8, further comprising a chain optimization circuit configured to optimize the function chain based on a calculation resource restriction or a performance optimization condition that is input to the input device.

10. The device according to claim 9, further comprising a dynamic chain control circuit configured to determine regeneration of the function chain based on system monitor information input to the input device.

11. The device according to claim 10, wherein the regeneration of the function chain is determined based on a value indicating a usage state of a calculation resource of an entire system or a value indicating a progress of processing in response to a processing request from the user.

12. The device according to claim 7, further comprising a chain optimization circuit configured to optimize the function chain based on a calculation resource restriction or a performance optimization condition that is input to the input device.

13. The device according to claim 7, further comprising a dynamic chain control circuit configured to determine regeneration of the function chain based on system monitor information input to the input device.

14. The device according to claim 13, wherein the regeneration of the function chain is determined based on a value indicating a usage state of a calculation resource of an entire system or a value indicating a progress of processing in response to a processing request from the user.

15. A calculation resource control method, the method comprising:
inputting a processing content specified by a user;
collecting candidates for a processing circuit having a function of executing a part of the processing content to output an equivalent circuit candidate group;
determining a processing execution circuit from the equivalent circuit candidate group; and
outputting a function chain for executing the processing content.

16. The method according to claim 15, wherein the processing execution circuit is determined by the processing content specified by the user.

17. The method according to claim 15, further comprising optimizing the function chain based on a calculation resource restriction or a performance optimization condition that is input by the user.

18. The method according to claim 15, further comprising determining regeneration of the function chain based on system monitor information input by the user.

19. The method according to claim 18, wherein determining the regeneration of the function chain is determined based on a value indicating a usage state of a calculation resource of an entire system or a value indicating a progress of processing in response to a processing request from the user.
